(19) United States
(12) Patent Application Publication
(10) Pub. No.: US 2021/0185982 A1
(43) Pub. Date: Jun. 24, 2021

(54) DOG TOY ASSEMBLY

(71) Applicants: George Bush, Cheyenne, WY (US); Mandy Bush, Cheyenne, WY (US)

(72) Inventors: George Bush, Cheyenne, WY (US); Mandy Bush, Cheyenne, WY (US)

(21) Appl. No.: 16/719,898

(22) Filed: Dec. 18, 2019

(51) Int. Cl. A01K 15/02; F16M 11/06

(52) U.S. Cl. CPC A01K 15/025; F16M 2200/08; F16M 2200/066; F16M 11/06

(57) ABSTRACT

A toy assembly; the toy assembly includes a stake and a receptacle. The receptacle is a bag which removably houses at least one pet toy. The toy assembly is capable of entertaining pets, particularly dogs, and provides a way for dogs to play by themselves if an owner/caretaker cannot play at a given time.

### CROSS REFERENCE TO RELATED APPLICATION

The present application is related to and claims priority to U.S. Provisional Patent Application No. 62/780,081 filed Dec. 14, 2018, which is incorporated by reference in its entirety.

### BACKGROUND OF THE INVENTION

The following includes information that may be useful in understanding the present disclosure. It is not an admission that any of the information provided is prior art nor material to the presently described or claimed inventions, nor that any publication or document that is specifically or implicitly referenced is prior art.

### 1. Field of the Invention

The present invention relates generally to the field of toys and more specifically relates to toys for pets.

### 2. Description of Related Art

Some dogs may require hours of playtime in order to maintain exercise requirements and burn off excess energy. Caretakers may not have endless hours to play with a dog. Some dogs may get bored and start digging in the yard or tearing apart household items. A suitable solution is desired.

U.S. Pat. No. 4,948,137 to Marcial Alvarez relates to a tethered playing device. The described tethered playing device includes a tethered line and a ball releasably suspended from the line. A handle is provided to manipulate the line to cause the ball to move. The dog jumps around and receives strenuous exercise in chasing the moving ball.

### BRIEF SUMMARY OF THE INVENTION

In view of the foregoing disadvantages inherent in the known toy art, the present disclosure provides a novel dog toy assembly. The general purpose of the present disclosure, which will be described subsequently in greater detail, is to provide a toy capable of keeping a dog entertained for a considerable amount of time. The toy offers a way for dogs to play by themselves if an owner/caretaker cannot play at a given time.

A toy assembly is disclosed. The toy assembly includes a stake which may include a non-pointed end, a pointed end, and a first length therebetween. The pointed end may be configured for insertion into a ground-surface. A receptacle may be attached to the stake along the first length and include a receptacle-capacity defined by a receptacle-body, an opening, and a closure mechanism located about a periphery of the opening configured to selectively close the opening. The receptacle-capacity may be sized to receive and removably hold at least one pet toy.

A method of using the toy assembly is also disclosed. The method of using toy assembly may comprise the steps of providing the toy assembly as above; removably placing the at least one pet toy within the receptacle-capacity; attaching the receptacle to the stake; and inserting the stake into the ground-surface.

For purposes of summarizing the invention, certain aspects, advantages, and novel features of the invention have been described. It is to be understood that not necessarily all such advantages may be achieved in accordance with any one particular embodiment of the invention. Thus, the invention may be embodied or carried out in a manner that achieves or optimizes one advantage or group of advantages as taught without necessarily achieving other advantages as may be taught or suggested. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a dog toy assembly, constructed and operative according to the teachings of the present disclosure.

FIG. 1 is a side perspective view of the toy assembly during an ‘in-use’ condition, according to an embodiment of the disclosure.

FIG. 2 is a side perspective view of the toy assembly of FIG. 1, according to an embodiment of the present disclosure.

FIG. 3A is a side perspective view of the toy assembly of FIG. 1, according to an embodiment of the present disclosure.

FIG. 3B is a top perspective view of the toy assembly of FIG. 1, according to an embodiment of the present disclosure.

FIG. 4 is a top perspective view of the toy assembly of FIG. 1, according to an embodiment of the present disclosure.

FIG. 5 is a flow diagram illustrating a method of use for the toy assembly, according to an embodiment of the present disclosure.

The various embodiments of the present invention will be described in conjunction with the appended drawings, wherein like designations denote like elements.

### DETAILED DESCRIPTION

As discussed above, embodiments of the present disclosure relate to toys and more particularly to a dog toy assembly as used to improve toys for pets.

Generally disclosed is a toy assembly which may comprise a stake equipped with a bag having an opening accessible via a drawstring. The stake may be constructed using steel or aluminum and inserted directly into the ground surface. The bag may be attached to the stake via a spring and clip, maximizing stability for toys inserted into the bag. The stake may be configured to support and stabilize the bag such that a dog may tug and pull on the bag/toy without pulling the stake out of the ground. The toy assembly may allow dogs to try and remove their toy from the bag, offering stimulation and entertainment while keeping the dog occupied.

The toy assembly may be manufactured in a variety of sizes. For example: a ‘large’ size may include a 12×12 bag with 1 1/18 in.×16 in. spring with a 32 lb working load; a ‘medium’ size may include a 12×12 bag with 9/16 in.×16 in. spring with a 9.5 lb working load; and a ‘small’ size may include a 10×10 bag with 7/16 in.×10 in. spring with a working load of 5 lb. It should be appreciated that these measurements and specifications are given as examples and are not meant to limit the size of any of the components or working load of the toy assembly.

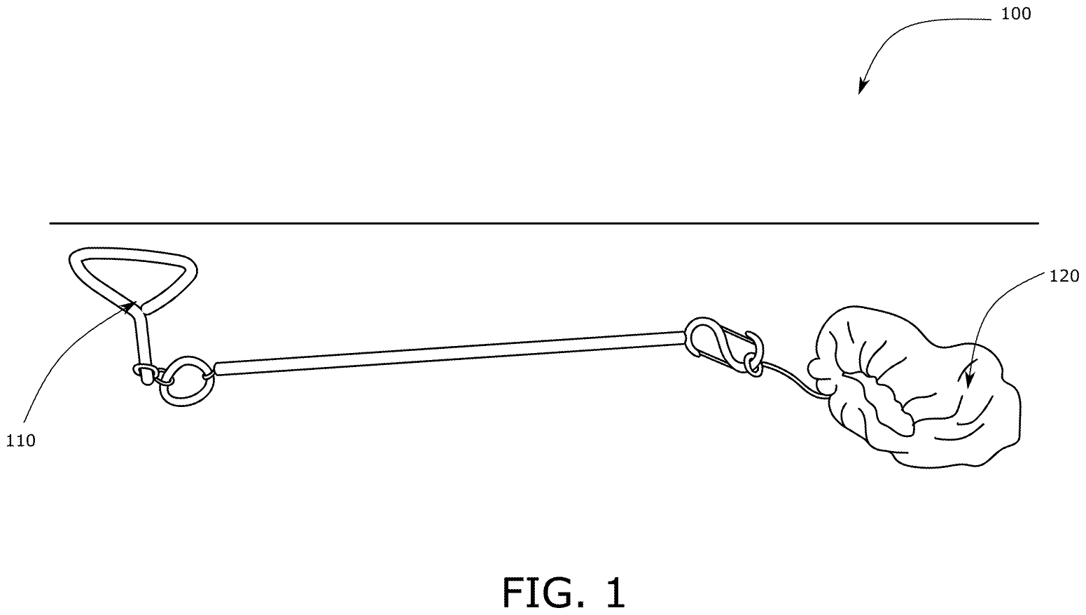

Referring now more specifically to the drawings by numerals of reference, there is shown in FIGS. 1-4, various views of a toy assembly 100.

FIG. 1 shows a toy assembly 100 during an ‘in-use’ condition 150, according to an embodiment of the present disclosure. As Illustrated, the toy assembly 100 may include a stake 110 and a receptacle 120. The toy assembly 100 may be used by a pet, such as a dog.

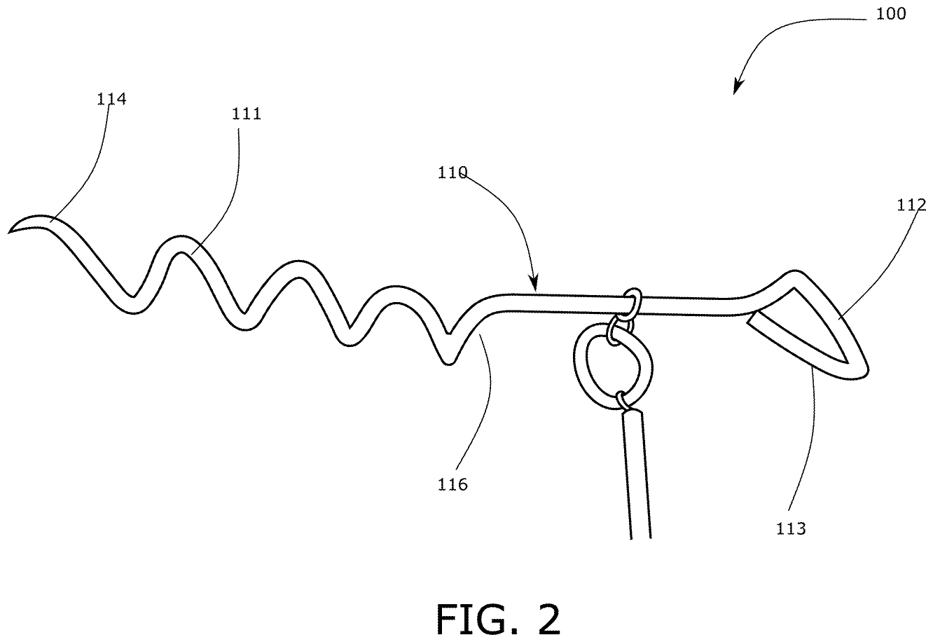

FIG. 2 shows a side perspective view of the toy assembly 100 of FIG. 1, according to an embodiment of the present disclosure. The stake 110 may include a non-pointed end 112, a pointed end 114, and a first length 116 therebetween. The stake 110 may comprise an aluminum material in one embodiment, or a steel material in another embodiment, or a mixture of the two. In other embodiments, other materials are contemplated and the stake 110 is not limited to being just aluminum or steel material.

Preferably, the pointed end 114 may be configured for insertion into a ground-surface. In one embodiment, the pointed end 114 may include a spiral configuration 111. This may be particularly useful for providing additional stability when inserted into the ground surface as the stake 110 is able to skewer into the ground surface. Further, the non-pointed end 112 may include a handle section 113. The handle section 113 may be useful to allow a user, such as a pet owner, to safely and easily remove and insert the stake 110 into the ground surface. For use inside, in some embodiments, the toy assembly 110 may include a suction cup (not illustrated) for attaching the toy assembly 110 to any nonporous surface. In this embodiment, the suction cup may replace the stake 110 or may be a removable addition.

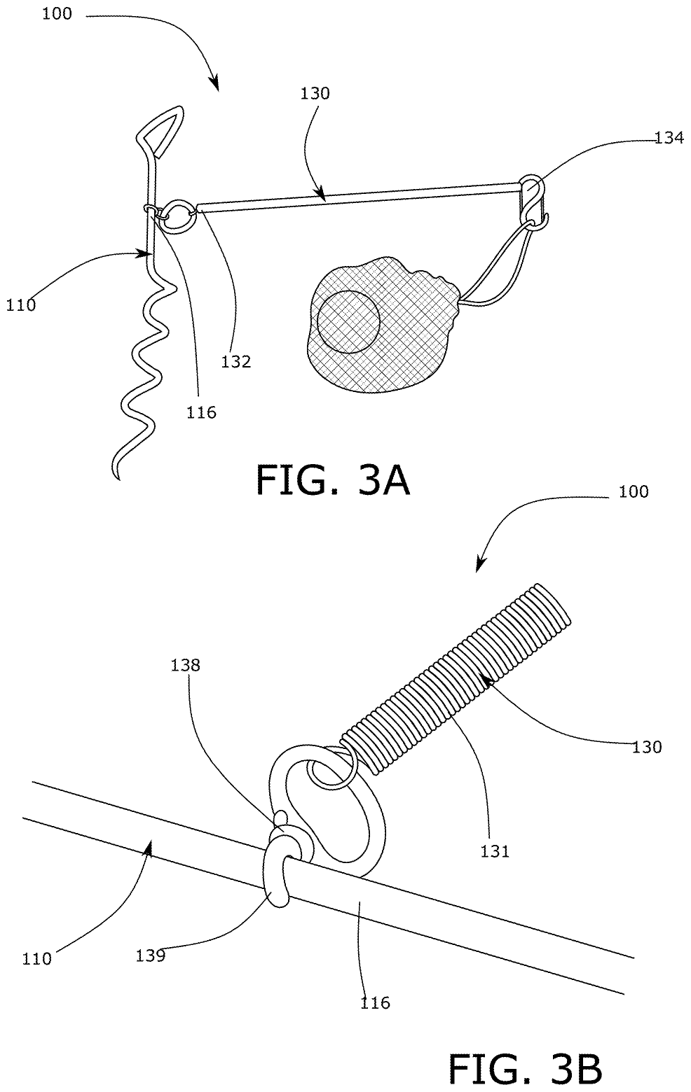

FIGS. 3A-3B show perspective views of the toy assembly 100 of FIG. 1, according to an embodiment of the present disclosure. As shown, the toy assembly 100 may further comprise an extension pole 130 including a pole first-end 132, a pole second-end 134, and a second length 136 therebetween. The pole first-end 132 of the extension pole 130 may be attached to the stake 110 about the first length 116. In one embodiment, the pole first-end 132 of the extension pole 130 may be attached to the stake 110 about the first length 116 via a swivel connection-means 138. This may be useful for allowing a pet to run around the stake 110 while grasping onto the extension pole 130.

Preferably, the swivel connection-means 138 may include a swivel clip 139. The swivel clip 139 may travel about the first length 116. For example, the swivel clip 139 may be selectively clipped around the first length 116 and can travel about the first length 116 to allow for a swiveling motion. To achieve this, the swivel clip 139 may include a clip-diameter larger than a stake-diameter of the first length 116. The clip-diameter may not be large enough to come loose from the first length, but large enough to allow for ease of motion. Further, the extension pole 130 may include at least one spring 131. This may provide a flexibility to the extension pole 130 to allow a pet to play ‘tug-of-war’ with the toy assembly 100 by grasping and pulling.

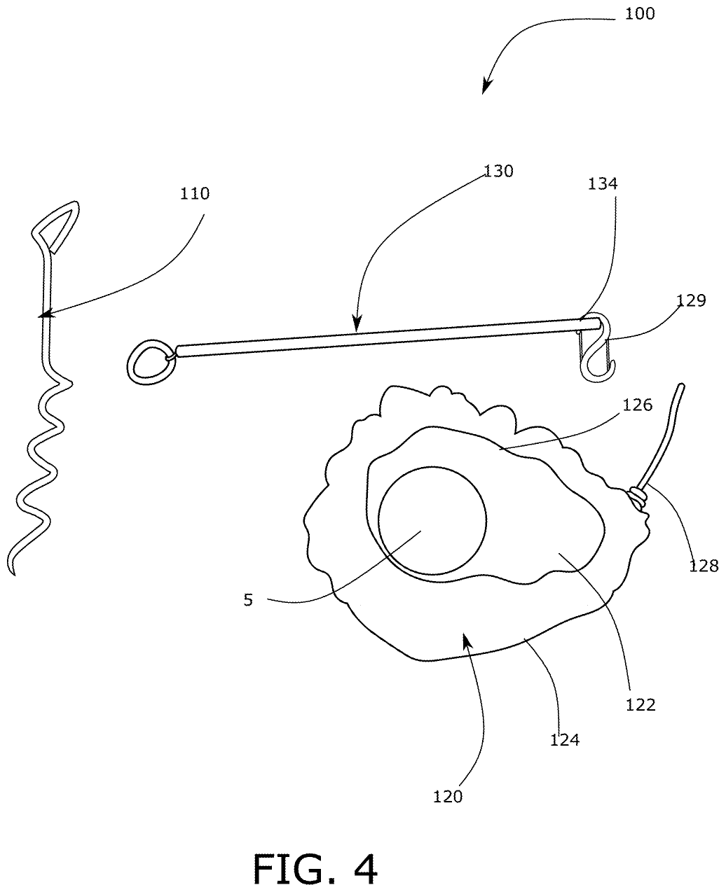

FIG. 4 shows a top perspective view of the toy assembly 100 of FIG. 1, according to an embodiment of the present disclosure. In one embodiment, the receptacle 120 may be attached to the stake 110 along the first length 116. The extension pole 130 may attach the receptacle to the stake 110. In this embodiment, the receptacle 120 may be attached to the extension pole 130 at the pole second-end 134. The pole second-end 134 may include a receptacle-clip 129 configured to attach the receptacle 120 to the extension pole 130. Further, the receptacle 120 may include a cord for facilitating attachment to the receptacle-clip 129. The receptacle-clip 129 may be a ⅛ quick link and is preferably extremely durable. For example, the receptacle-clip 129 may include a working load of 2201b.

The receptacle 120 may include a receptacle-capacity 122 defined by a receptacle-body 124, an opening 126, and a closure mechanism 128 located about a periphery of the opening 126 configured to selectively close the opening 126. The receptacle-capacity 122 may be sized to receive and removably hold at least one pet toy 5. In one embodiment, the at least one pet toy 5 may include a ball having a ball-diameter of at least 3 inches, and the receptacle-capacity 122 may be sized to receive and removably hold the ball-diameter of at least 3 inches. However, it is contemplated that the user, or pet owner, may use a variety of pet toys that are differently shaped and sized, and may utilize more than one at any given time.

The receptacle-body 124 may comprise a net. The net may be durable enough to allow the pet to bite and not tear the receptacle-body 124. Preferably, the cord and the receptacle-body 124 may be made from a 550 paracord (parachute cord) material preferably with a working load of 150 lbs to allow the cord and receptacle 120 to withstand aggressive play by the pet. The net may allow for visibility into the receptacle-capacity 122 such that the pet is able to see the at least one pet toy 5 which may encourage them to play with it. The closure mechanism 128 may be slack enough to allow the pet to open the opening 126 by themselves to release the at least one pet toy 5. To achieve this, the closure mechanism 128 may be a drawstring. The receptacle 120 may be created by cutting a piece of paracord netting into a square (12×12 for a large or medium toy, 10×10 for a small toy), and lacing the piece of paracord netting to cinch (not fully close) the receptacle 120 which may allow for the pet toy 5 to be released by the pet.

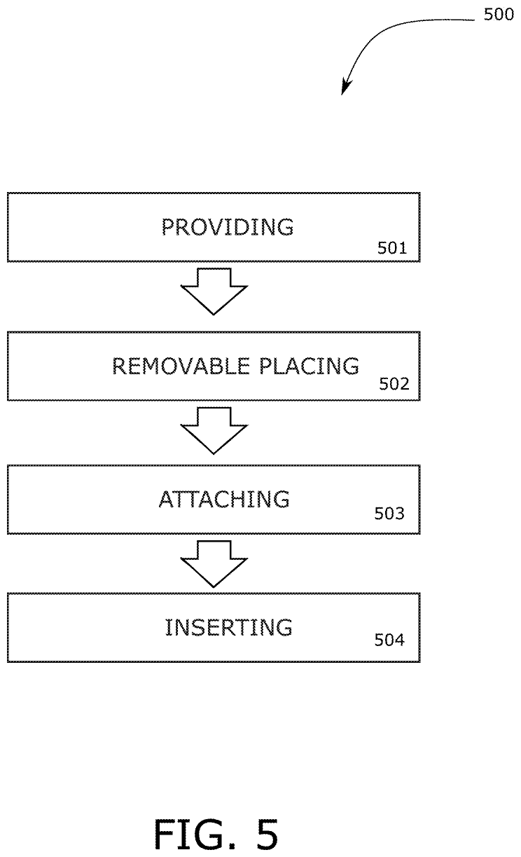

FIG. 5 is a flow diagram illustrating a method of using a toy assembly for a pet 500, according to an embodiment of the present disclosure. As illustrated, the method of using a toy assembly for a pet 500 may include the steps of: providing 501 the toy assembly as above; removably placing 502 the at least one pet toy within the receptacle-capacity; attaching 503 the receptacle to the stake; and inserting 504 the stake into the ground-surface. It is contemplated that the user, or pet owner, may place any toy into the receptacle-capacity and insert the stake into the ground. The pet (preferably a dog) would then play tug-of-war with the toy assembly and work to get the toy out of the receptacle-capacity.

It should be noted that the steps described in the method of use can be carried out in many different orders according to user preference. The use of “step of” should not be interpreted as “step for”, in the claims and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for toy assembly 100 (e.g., different step orders within above-mentioned list, elimination or addition of certain steps, including or excluding certain maintenance steps, etc.), are taught.

The embodiments of the invention described are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A toy assembly for a pet, the toy assembly comprising:
a stake including a non-pointed end, a pointed end, and a first length therebetween, the pointed end configured for insertion into a ground-surface;
and
a receptacle attached to the stake along the first length, the receptacle including a receptacle-capacity defined by a receptacle-body, an opening, and a closure mechanism located about a periphery of the opening configured to selectively close the opening,
wherein the receptacle-capacity is sized to receive and removably hold at least one pet toy.

2. The toy assembly of claim 1, further comprising an extension pole including a pole first-end, a pole second-end, and a second length therebetween.

3. The toy assembly of claim 2, wherein the pole first-end of the extension pole is attached to the stake about the first length.

4. The toy assembly of claim 3, wherein the pole first-end of the extension pole is attached to the stake about the first length via a swivel connection-means.

5. The toy assembly of claim 4, wherein the swivel connection-means includes a swivel clip.

6. The toy assembly of claim 5, wherein the swivel clip travels about the first length.

7. The toy assembly of claim 6, wherein the swivel clip includes a clip-diameter larger than a stake-diameter of the first length.

8. The toy assembly of claim 7, wherein the receptacle is attached to the extension pole at the pole second-end.

9. The toy assembly of claim 8, wherein pole second-end includes a receptacle-clip configured to attach the receptacle to the extension pole.

10. The toy assembly of claim 9, wherein the extension pole attaches the receptacle to the stake.

11. The toy assembly of claim 2, wherein the extension pole includes at least one spring.

12. The toy assembly of claim 1, wherein the closure mechanism is a drawstring.

13. The toy assembly of claim 12, wherein the receptacle-body comprises a net.

14. The toy assembly of claim 1, wherein the at least one pet toy includes a ball having a ball-diameter of at least 3 inches, and wherein the receptacle-capacity is sized to receive and removably hold the ball-diameter of at least 3 inches.

15. The toy assembly of claim 1, wherein the pointed end includes a spiral configuration.

16. The toy assembly of claim 1, wherein the non-pointed end includes a handle section.

17. The toy assembly of claim 1, wherein the stake comprises aluminum material.

18. The toy assembly of claim 1, wherein the stake comprises steel material.

19. A toy assembly for a pet, the toy assembly comprising:
a stake including a non-pointed end, a pointed end, and a first length therebetween, the pointed end being configured for insertion into a ground-surface;
a receptacle attached to the stake along the first length, the receptacle including a receptacle-capacity defined by a receptacle-body, an opening, and a closure mechanism located about a periphery of the opening configured to selectively close the opening, and wherein the receptacle-capacity is sized to receive and removably hold at least one pet toy; and
an extension pole including a pole first-end, a pole second-end, and a second length therebetween; and
wherein the pole first-end of the extension pole is attached to the stake about the first length;
wherein the pole first-end of the extension pole is attached to the stake about the first length via a swivel connection-means;
wherein the swivel connection-means includes a swivel clip;
wherein the swivel clip travels about the first length;
wherein the swivel clip includes a clip-diameter larger than a stake-diameter of the first length;
wherein the receptacle is attached to the extension pole at the pole second end;
wherein pole second-end includes a receptacle-clip configured to attach the receptacle to the extension pole;
wherein the extension pole attaches the receptacle to the stake;
wherein the extension pole includes at least one spring;
wherein the closure mechanism is a drawstring;
wherein the receptacle-body comprises a net;
wherein the at least one pet toy includes a ball having a ball-diameter of at least 3 inches, and wherein the receptacle-capacity is sized to receive and removably hold the ball-diameter of at least 3 inches;
wherein the pointed end includes a spiral configuration; and
wherein the non-pointed end includes a handle section.

20. A method of using a toy assembly for a pet, the method comprising the steps of:
providing the toy assembly for the pet, the toy assembly including:
a stake including a non-pointed end, a pointed end, and a first length therebetween, the pointed end configured for insertion into a ground-surface; and
a receptacle attached to the stake along the first length, the receptacle including a receptacle-capacity defined by a receptacle-body, an opening, and a closure mechanism located about a periphery of the opening configured to selectively close the opening, and wherein the receptacle-capacity is sized to receive and removably hold at least one pet toy;
removably placing the at least one pet toy within the receptacle-capacity;
attaching the receptacle to the stake; and
inserting the stake into the ground-surface.
